(19) United States
(12) Patent Application Publication
(10) Pub. No.: US 2024/0066996 A1
(43) Pub. Date: Feb. 29, 2024

(54) BATTERY SYSTEM FOR ELECTRIC VEHICLES AND CONTROL METHOD THEREOF

(71) Applicant: MIH CONSORTIUM, Taipei (TW)

(72) Inventor: KUO-HUA CHEN, Taipei (TW)

(73) Assignee: MIH CONSORTIUM, Taipei (TW)

(21) Appl. No.: 18/237,134

(22) Filed: Aug. 23, 2023

Related U.S. Application Data
(60) Provisional application No. 63/400,198, filed on Aug. 23, 2022.

(51) Int. Cl. B60L 15/20; B60L 50/60; B60L 58/19; B60L 58/22

(52) U.S. Cl. CPC B60L 15/20; B60L 50/60; B60L 58/19; B60L 58/22; B60L 53/80

(57) ABSTRACT

A battery system for an electric vehicle is provided. The electric vehicle includes a motor and a vehicle control unit. The battery system includes a first battery module, a second battery module configured to accommodate a plurality of swappable batteries, and a power control module configured to receive a driving intention from the vehicle control unit and switch a power supplying configuration of the motor according to the driving intention. The power supplying configuration includes a power supply by the first battery module only, a power supply by the second battery module only, a power supply by the first battery module and the second battery module in series, and a power supply by the first battery module and the second battery module in parallel.

### CROSS-REFERENCE TO RELATED APPLICATION

The present application claims the benefit of and priority to U.S. Provisional Patent Application Ser. No. 63/400,198, filed on Aug. 23, 2022, entitled “FIXED AND SWAPPABLE BATTERY DESIGN,” the contents of which are hereby fully incorporated herein by reference for all purposes.

### FIELD

The present disclosure generally relates to batteries for electric vehicles and, more particularly, to a battery system and a control method of the battery system for electric vehicles.

### BACKGROUND

Hybrid and electric vehicles are becoming increasingly common. These vehicles offer some advantages over traditional internal combustion engine vehicles. For example, hybrid or electric vehicles may save fuel and emit only a small amount or even no tailpipe emissions. In particular, electric vehicles not only have zero tailpipe emissions, but also reduce overall pollution in densely populated areas.

With the development of new battery technologies such as lithium-ion batteries and solid-state batteries, the maximum driving distance of electric vehicles has become more acceptable. However, electric vehicles encounter many variables during operation, such as road conditions, traffic conditions, temperature, payload, and even driver's driving conditions, which may affect the efficiency and capacity of the battery, making it difficult to accurately estimate the remaining driving distance that the battery may provide. Therefore, the expansion and efficiency of electric vehicle batteries are issues that need to be addressed.

### SUMMARY

In view of the above, the present disclosure provides a battery system and its control method for electric vehicles (EVs), which may improve the convenience of battery replacement and the power supply efficiency of the battery system.

A first aspect of the present disclosure provides a battery system configured for electric vehicles. The electric vehicle includes a motor and a vehicle control unit that generates driving intentions. The battery system includes a first battery module, a second battery module, and a power control module. The second battery module is configured to accommodate several swappable batteries. The power control module is coupled to the first battery module, the second battery module, the motor and the vehicle control unit, and configured to receive driving intentions from the vehicle control unit and switch a power supplying configuration of the motor based on the driving intention. The power supplying configuration includes a power supply by the first battery module only, a power supply by the second battery module only, a power supply by the first battery module and the second battery module in series, and a power supply by the first battery module and the second battery module in parallel.

In some implementations of the first aspect, the battery system includes at least one voltage adjusting device coupled between the first battery module, the second battery module and the motor. The voltage adjusting device is configured to adjust the voltage difference between the first battery module and the second battery module when the first battery module and the second battery are connected in parallel.

In some implementations of the first aspect, adjusting the voltage difference between the first battery module and the second battery module includes at least one of reducing a first output voltage of the first battery module and increasing a second output voltage of the second battery module.

In some implementations of the first aspect, the driving intention includes a required torque of the electric vehicle. The power control module switches the power supplying configuration of the motor to the power supply by the first battery module and the second battery module in parallel when the required torque is greater than a first torque threshold.

In some implementations of the first aspect, the driving intention also includes a required rotational speed of the electric vehicle. The power control module switches the power supplying configuration of the motor to the power supply by the first battery module and the second battery module in series when the required torque is not greater than (e.g., less than or equal to) the first torque threshold and the required rotational speed is greater than a first rotational speed threshold.

In some implementations of the first aspect, the power control module switches the power supplying configuration of the motor to the power supply by the first battery module or the second battery module when the required torque is not greater than (e.g., less than or equal to) the first torque threshold.

In some implementations of the first aspect, the driving intention further includes a required rotational speed of the electric vehicle. The power control module switches the power supplying configuration of the motor to the power supply by the second battery module when the required torque is not greater than (e.g., less than or equal to) a second torque threshold and the required rotational speed is not greater than (e.g., less than or equal to) a second rotational speed threshold.

In some implementations of the first aspect, the battery system further includes a power management system. The power management system is coupled to the first battery module, the second battery module and the power control module, and configured to provide a current state of the first battery module and the second battery module to the power control module. The power control module switches the power supplying configuration of the motor according to the driving intention and the current state.

In some implementations of the first aspect, the power control module connects the multiple swappable batteries of the second battery module in parallel when switching the power supplying configuration of the motor to the power supply by the first battery module and the second battery module in series.

In some implementations of the first aspect, the power control module connects the multiple swappable batteries of the second battery module in series when switching the power supplying configuration of the motor to the power supply by the first battery module and the second battery module in parallel.

A second aspect of the present disclosure provides a control method of a battery system applicable in an electric vehicle. The battery system includes a first battery module and a second battery module configured to accommodate multiple swappable batteries. The control method includes receiving a driving intention from a vehicle control unit; and switches a power supplying configuration of a motor of the electric vehicle based on the driving intention, the power supplying configuration including a power supply by the first battery module only, a power supply by the second battery module only, a power supply by the first battery module and the second battery module in series, and a power supply by the first battery module and the second battery module in parallel.

In some implementations of the second aspect, the battery system further includes at least one voltage adjusting device coupled between the first battery module, the second battery module and the motor. Switching the power supplying configuration of the motor of the electric vehicle based on the driving intention includes adjusting a voltage difference between the first battery module and the second battery module when the first battery module and the second battery module are connected in parallel.

In some implementations of the second aspect, adjusting the voltage difference between the first battery module and the second battery module includes at least one of reducing a first output voltage of the first battery module and increasing a second output voltage of the second battery module.

In some implementations of the second aspect, the driving intention includes a required torque of the electric vehicle, switching the power supplying configuration of the motor of the electric vehicle based on the driving intention includes determining whether the required torque is greater than a first torque threshold, and when determined the required torque is determined to be greater than the first torque threshold, switching the power supplying configuration of the motor to the power supply by the first battery module and the second battery module in parallel.

In some implementations of the second aspect, the driving intention further includes a required rotational speed of the electric vehicle, and switching the power supplying configuration of the motor of the electric vehicle based on the driving intention further includes: determining whether the required rotational speed is greater than the first rotational speed threshold when the required torque is determined to be not greater than (e.g., less than or equal to) the first torque threshold; and when the required rotational speed is determined to be greater than the first rotational speed threshold, switching the power supplying configuration of the motor to the power supply by the first battery module and the second battery module in series.

In some implementations of the second aspect, switching the power supplying configuration of the motor of the electric vehicle based on the driving intention further includes: when the required torque is determined to be not greater than (e.g., less than or equal to) the first torque threshold, switching the power supplying configuration of the motor to the power supply by the first battery module only or the second battery module only.

In some implementations of the second aspect, the driving intention further includes a required rotational speed of the electric vehicle, and switching the power supplying configuration of the motor of the electric vehicle based on the driving intention further includes: when the required torque is determined to be not greater than (e.g., less than or equal to) the first torque threshold, determining whether the required torque is greater than the second torque threshold; when the required torque is determined to be not greater than (e.g., less than or equal to) the second torque threshold, determining whether the required rotational speed is greater than the second rotational speed threshold; and when the required rotational speed is determined to be not greater than (e.g., less than or equal to) the second rotational speed threshold, switching the power supplying configuration of the motor to the power supply by the second battery module only.

In some implementations of the second aspect, the control method further includes acquiring the current state of the first battery module and the second battery module; and switches the power supplying configuration of the motor based on the driving intention and the current state.

In some implementations of the second aspect, switching the power supplying configuration of the motor of the electric vehicle includes: connecting the multiple swappable batteries of the second battery module in parallel when switching the power supplying configuration of the motor to the power supply by the first battery module and the second battery module in series.

In some implementations of the second aspect, switching the power supplying configuration of the motor of the electric vehicle includes: connecting the multiple swappable batteries of the second battery module in series when switching the power supplying configuration of the motor to the power supply by the power supplying configuration of the motor to the power supply by the first battery module and the second battery module in parallel.

Based on the above, the battery system and its control method provided in the present disclosure expand the capacity and voltage or current that may be provided by the battery system using swappable batteries, and may switch the power supplying configuration of the battery system for the motor according to the driving intention, which improves the convenience of battery swapping and the power supply efficiency of the battery system.

### BRIEF DESCRIPTION OF THE DRAWINGS

FIG. 1 illustrates a block diagram of a battery system in accordance with an example implementation of the present disclosure.

FIG. 2 illustrates a block diagram of a battery system in accordance with an example implementation of the present disclosure.

FIG. 3 illustrates a flowchart of a control method for a battery system in accordance with an example implementation of the present disclosure.

### DETAILED DESCRIPTION

The following description contains specific information related to exemplary implementations of the present disclosure. The drawings and their accompanying detailed descriptions in the present disclosure are merely exemplary implementations. However, the present disclosure is not limited to these exemplary implementations. Those skilled in the art will appreciate various modifications and alternative implementations of the present disclosure are possible. Unless otherwise indicated, identical or corresponding elements in the drawings may be indicated by the same or corresponding reference numerals. In addition, the drawings and examples in the present disclosure are generally not drawn to scale and do not correspond to actual relative sizes.

For the sake of consistency and clarity, similar features are labeled with the same reference numerals in the exemplary drawings (although this may not be the case in some examples). However, features in different implementations may differ in other respects, and should not be narrowly interpreted based solely on the features shown in the drawings.

The terms “at least one implementation,” “an implementation,” “multiple implementations,” “different implementations,” “some implementations,” and “the present implementation,” as used herein, may include specific features, structures, or characteristics, but not every possible implementation necessarily includes the particular features, structures, or characteristics. Additionally, the repeated use of phrases such as “in one implementation,” “in the present implementation,” does not necessarily refer to the same implementation, although they may be the same. Furthermore, phrases such as “implementations of the disclosure” associated with the term “the present disclosure” does not mean that all implementations of the disclosure necessarily include particular features, structures, or characteristics and should be understood to mean that “at least some implementations of the disclosure” include the specific features, structures, or characteristics described. The term “coupled” is defined as connected, whether directly or indirectly through intermediate components, and is not necessarily limited to physical connections. When the term “comprising” is used, it means “including but not limited to,” explicitly indicating an open-ended inclusion or relationship of combinations, groups, series, and the like.

Furthermore, specific details such as functional entities, technologies, protocols, standards, etc. have been explained for the purpose of explanation and non-limitation to provide an understanding of the described technology. In other examples, detailed descriptions of well-known methods, technologies, systems, architectures, etc. are omitted to avoid confusing the explanatory description with unnecessary details.

The terms “first,” “second,” and “third,” etc. used in the specification and the accompanying drawings of the present disclosure are intended to distinguish between different objects, rather than to describe a particular order. In addition, the term “comprising” and any variations thereof are intended to cover non-exclusive inclusion. For example, a process, method, system, product, or apparatus that includes a series of steps or modules is not limited to the listed steps or modules but may optionally include additional steps or modules not listed, or optionally include additional steps or modules inherent in such processes, methods, products, or apparatus.

The following description is provided in conjunction with the accompanying drawings to illustrate implementations of the present disclosure.

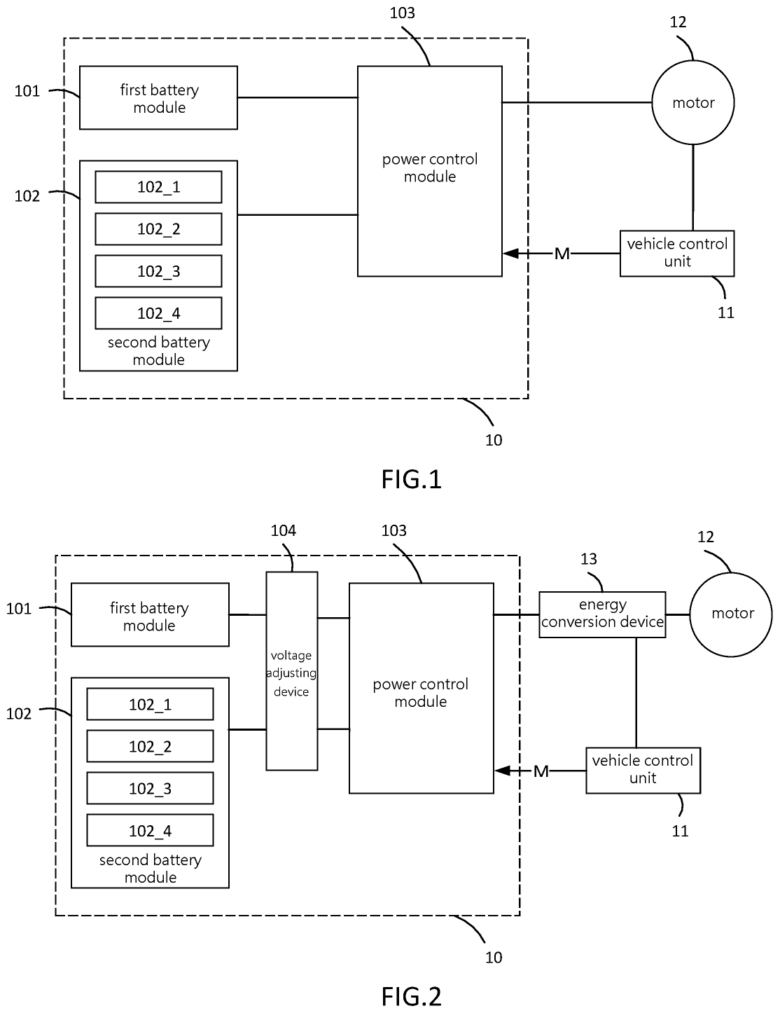

FIG. 1 illustrates a block diagram of a battery system in an implementation of the present disclosure, and FIG. 2 illustrates a block diagram of a battery system in an implementation of the present disclosure.

Referring to FIGS. 1 and 2, an electric vehicle (EV) includes a motor 12 and a vehicle control unit (VCU) 11. The vehicle control unit 11 is used to generate a driving intention M. It should be noted that the term “electric vehicle” mentioned in this application may refer to any vehicle that at least partially uses stored electrical energy as a power source, and may not be limited to cars or motorcycles that travel on land. It may also include boats that travel on water or airplanes that fly in the air.

In some implementations, the vehicle control unit 11 acquires information such as gear position and/or pedal position of the electric vehicle, and generates driving intention M based on this information. In some implementations, the driving intention M includes the required voltage and/or current of the electric vehicle. In some implementations, the driving intention M includes at least one of the required torque and required rotational speed of the electric vehicle. For example, the required torque of the electric vehicle may be determined by the pedal position, while the required rotational speed may be determined by the pedal depth, gear position, and/or motor 12, among other factors.

In some implementations, the battery system 10 is configured to supply energy to the electric vehicle includes a first battery module 101, a second battery module 102, and a power control module 103, wherein the power control module 103 is coupled to the first battery module 101, the second battery module 102, the motor 12, and the vehicle control unit 11.

In some implementations, the first battery module 101 may include a first type of battery, which is typically fixed to the electric vehicle and has a larger volume, weight, and voltage. For example, the first type of battery may be a lead-acid battery, a nickel-hydrogen battery, a nickel-zinc battery, a nickel-cadmium battery, a lithium-ion battery, or the like, and may provide several hundred volts of voltage (e.g., 300 to 400 volts), but the present disclosure is not limited thereto. In addition, in order to achieve an acceptable storage capacity, the first type of battery used in electric vehicles often weighs several hundred kilograms (e.g., 300 to 400 kilograms), making it difficult to replace. Once the remaining power is insufficient, it is necessary to spend a lot of time at a charging station to charge it. To solve the above problems and further improve the convenience of electric vehicles and the flexibility of battery configuration, the battery system 10 of the present disclosure further includes a second battery module 102.

In some implementations, the second battery module 102 may accommodate multiple swappable batteries, for example, a second type of battery. The second type of battery, for example, may be a heterogeneous battery compared to the first type of battery, featuring smaller volume, weight and voltage. For example, the second type of battery may be a lithium battery, a solid-state battery, each providing tens of volts of voltage (e.g., 30 to 50 volts) and weighing a few kilograms (e.g., 9 kilograms), but the present disclosure is not limited thereto. Advantageously, based on the above characteristics of the second type of battery and the current prevalence of battery swapping stations of the second type of battery, users may more easily and conveniently replace the swappable batteries in the second battery module 102.

In some implementations, the second battery module 102 may include multiple slots 120_1-120_4 that are compatible with swappable batteries. In some implementations, each of the slots 120_1-120_4 may be coupled to the power control module 103, and the power control module 103 may switch the series-parallel state between multiple swappable batteries in the multiple slots 120_1-120_4.

In addition, it should be noted that although four slots 120_1 to 120_4 are shown in the drawings as being located in the second battery module 102, those skilled in the art should understand that the second battery module 102 may also include two, three, or more than four slots. The present disclosure does not limit the number of slots in the second battery module 102.

Advantageously, the addition of the second battery module 102 may also further enhances the performance of the electric vehicle. For example, when the first battery module 101 is connected in series with the second battery module 102, the output voltage may be increased to drive the motor 12 to a higher rotational speed, and when the first battery module 101 is connected in parallel with the second battery module 102, the output current may be increased to achieve higher torque.

In some implementations, the battery system 10 may additionally include one or more battery modules (e.g., a third battery module (not shown)). In some cases, one or more additional battery modules may include a first type of battery similar to the first battery module 101; in some cases, one or more additional battery modules may include multiple slots compatible with swappable batteries similar to the second battery module 102.

In some implementations, the power control module 103 is configured to receive a driving intention M from the vehicle control unit 11 and switch the power supplying configuration of the motor 12 according to the driving intention M. Specifically, switching the power supplying configuration of the motor 12 includes selecting which battery module or modules to supply power for the motor 12 and the connection configuration between the selected battery modules.

In some implementations, the power control module 103 may include a power supply switching device (not shown) and a power control unit (PCU) (not shown) coupled to the power supply switching device. The power control unit is configured to receive signals (e.g., driving intention M) from the vehicle control unit 11, determine which battery module or modules to supply power for the motor 12 and the connection configuration between the selected battery modules based on the received signals, and then control the power supply switching device accordingly. In some implementations, although not shown in FIG. 1, the power control module 103 may further include other components such as a battery management system (BMS), a voltage stabilizing circuit, etc., and the present disclosure is not limited thereto. For example, the battery management system may be configured to obtain the current state of each battery module (e.g., voltage, remaining power, etc.), and the power control unit may determine based on the driving intention M and the current state of each battery module.

In some implementations, the battery system 10 includes a first battery module 101 and a second battery module 102. Therefore, the switchable power supplying configuration include:
(1) power supply by the first battery module 101 only;
(2) power supply by the second battery module 102 only;
(3) power supply by the first battery module 101 and the second battery module 102 in series; and
(4) power supply by the first battery module 101 and the second battery module 102 in parallel.

In some implementations, the battery system 10 includes a first battery module 101, a second battery module 102, and a third battery module. Therefore, the switchable power supplying configuration include:
(1) power supply by the first battery module 101 only;
(2) power supply by the second battery module 102 only;
(3) power supply by the third battery module only;
(4) power supply by connecting the first battery module 101 and the second battery module 102 in series, and then connecting them with the third battery module in parallel;
(5) power supply by connecting the first battery module 101 and the third battery module in series, and then connecting them with the second battery module 102 in parallel;
(6) power supply by connecting the second battery module 102 and the third battery module in series, and then connecting them with the first battery module 101 in parallel;
(7) power supply by connecting the first battery module 101 and the second battery module 102 in parallel, and then connecting them with the third battery module in series;
(8) power supply by connecting the first battery module 101 and the third battery module in parallel, and then connecting them with the second battery module 102 in series;
(9) power supply by connecting the second battery module 102 and the third battery module in parallel, and then connecting them with the first battery module 101 in series;
(10) power supply by the first battery module 101, the second battery module 102, and the third battery module in series; and
(11) power supply by the first battery module 101, the second battery module 102, and the third battery module in parallel.

In other implementations, when the battery system 10 has more battery modules, the switchable power supplying configuration may also include more different combinations and connection configuration, which will not be described in detail here. In addition, for the sake of simplicity, multiple implementations in this specification will be described using two battery modules (e.g., first battery module 101 and second battery module 102) as examples. Those skilled in the art will understand that the disclosure herein may be applied to the situation with the aforementioned three or more battery modules based on the description in this specification.

Referring to FIG. 2, in some implementations, the battery system 10 further includes at least one voltage adjusting device 104 coupled between the battery modules (e.g., the first battery module 101 and the second battery module 102) and the motor 12 is configured to adjust the voltage difference between the parallel battery modules. For example, when the power supplying configuration is the first battery module 101 and the second battery module 102 in parallel, the voltage difference between the first battery module 101 and the second battery module 102 is adjusted, such as, decreasing the first output voltage of the first battery module 101 and/or increasing the second output voltage of the second battery module 102. For instance, the voltage adjusting device 104 may be a transformer connected between the first battery module 101 and the power control module 103 and/or between the second battery module 102 and the power control module 103. Advantageously, adding the voltage adjusting device 104 between the battery modules and the motor 12 or the power control module 103 may avoid damage to the battery modules caused by excessive voltage difference between the two battery modules in parallel.

In some implementations, the electric vehicle further includes an energy conversion device 13. The power control module 103 (e.g., power supply switching device) is coupled between the battery modules (e.g., the first battery module 101 and the second battery module 102) and the energy conversion device 13. In some implementations, the energy conversion device 13 is configured to convert the energy from the battery modules (e.g., the first battery module 101 and/or the second battery module 102) into a form suitable for the motor 12 of the electric vehicle and provide it for the motor 12. For example, the energy conversion device 13 may be an inverter that converts the DC power from the first battery module 101 and/or the second battery module 102 into AC power and provides it for the motor 12.

In some implementations, the power control module 103 (e.g., power supply switching device) may be configured to switch not only the power supply for the motor 12, but also the series-parallel state of several swappable batteries in the second battery module 102. For example, the power control module 103 switches the power supplying configuration of the motor 12 to the power supply by the multiple swappable batteries of the second battery module 102 to parallel when switching the first battery module 101 and the second battery module 102 to series. Similarly, the power control module 103 switches the power supplying configuration of the motor 12 to the power supply by the multiple swappable batteries in the second battery module 102 to series when switching the first battery module 101 and the second battery module 102 to parallel.

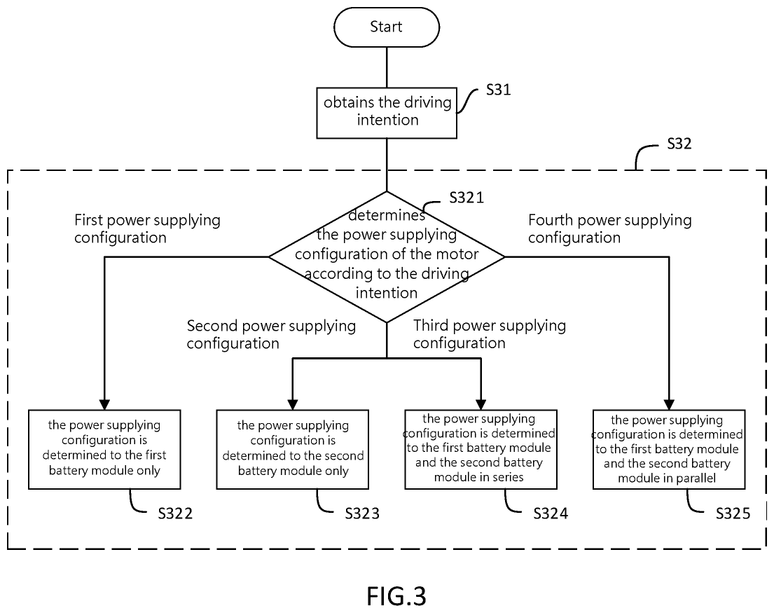

FIG. 3 illustrates a flowchart of a control method for a battery system in an implementation of the present disclosure.

Referring to FIG. 3, in step S31, the power control module 103 obtains the driving intention M from the vehicle control unit 11; in step S32, the power control module 103 switches the power supplying configuration of the motor 12 based on the driving intention M.

In some implementations, the power control module 103 determines and switches the power supplying configuration of the motor 12 based on the driving intention M and the current state of each battery module from the battery management system. Specifically, the power control module 103 refers to the current state of each battery module to find the optimal power supplying configuration of the motor 12 that meets the driving intention M and switches it accordingly. For example, the power control module 103 may select one or more battery modules from multiple battery modules then determines and switches the connection configuration between the selected battery module(s) and the motor 12. It should be noted that the details of selecting one or more battery modules from multiple battery modules and determining their connection configuration with the motor 12 are not described in detail in this present disclosure.

In some implementations, the power control module 103 may be configured with default rules, where each driving intention M corresponds to one of multiple power supplying configuration. For example, the default rules may divide the rotational speed and torque into multiple intervals (e.g., but not limited to, 3 intervals), and each driving intention M corresponds to one of multiple power supplying configuration (e.g., but not limited to, the first power supplying configuration, the second power supplying configuration, the third power supplying configuration, and the fourth power supplying configuration). After the power control module 103 (e.g., the power control unit) obtains the required rotational speed and required torque of the electric vehicle, one may refer to the default rules to determine the power supplying configuration of the motor 12, and then switched the connection configuration between the battery module and the motor 12 based on the determined power supplying configuration (e.g., by the power supply switching device).

For example, the default rules may be presented in the following table, where the first power supplying configuration is supplied by the first battery module 101 only, the second power supplying configuration is supplied by the second swappable battery module 102 only, the third power supplying configuration is supplied by the first swappable battery module 101 and the second swappable battery module 102 in series, and the fourth power supplying configuration is supplied by the first swappable battery module 101 and the second swappable battery module 102 in parallel.

TABLE 1

| | First rotational | Second rotational | Third rotational |
|---|---|---|---|
| | speed Interval | speed Interval | speed Interval |
| First torque | Second power | First power | First power |
| Interval | supplying | supplying | supplying |
| | configuration | configuration | configuration |
| Second torque | First power | First power | Third power |
| Interval | supplying | supplying | supplying |
| | configuration | configuration | configuration |
| Third torque | Fourth power | Fourth power | Fourth power |
| Interval | supplying | supplying | supplying |
| | configuration | configuration | configuration |

In some implementations, step S32 may include steps S321 to S325.

In step S321, the power control module 103 (e.g., the power control unit) determines the power supplying configuration of the motor 12 according to the driving intention M; if the power supplying configuration of the motor 12 is determined to the first battery module 101 only, step S322 is executed; if the power supplying configuration of the motor 12 is determined to the first battery module 101 and the second battery module 102 in parallel, step S323 is executed; if the power supplying configuration of the motor 12 is determined to the third power supplying configuration, step S324 is executed; if the power supplying configuration of the motor 12 is determined to the fourth power supplying configuration, step S325 is executed.

For example, referring to Table 1, when the driving intention M indicates the required rotational speed of the electric vehicle falls within the first rotational speed interval and the required torque falls within the first torque interval, the power control module 103 determines the power supplying configuration of the motor 12 to the second power supplying configuration. If the driving intention M indicates the required torque of the electric vehicle falls within the third torque interval, the power control module 103 determines to supply power for the motor 12 by the fourth power supplying configuration. If the driving intention M indicates the required rotational speed of the electric vehicle falls within the third rotational speed interval and the required torque falls within the second torque interval, the power control module 103 determines the power supplying configuration of the motor 12 to the third power supplying configuration. If the driving intention M indicates other situations, the power control module 103 determines the power supplying configuration of the motor 12 to the first power supplying configuration.

From another perspective, the first torque threshold and the second torque threshold may define the first torque interval, the second torque interval, and the third torque interval; while the first rotational speed threshold and the second rotational speed threshold may define the first rotational speed interval, the second rotational speed interval, and the third rotational speed interval. For example, when the torque/rotational speed is greater than the first torque/rotational speed threshold, the torque/rotational speed falls between the third torque/rotational speed interval; when the torque/rotational speed is greater than the second torque/rotational speed threshold and not greater than (e.g., less than or equal to) the first torque/rotational speed, the torque falls between the second torque/rotational speed interval; when the torque/rotational speed is not greater than (e.g., less than or equal to) the second torque/rotational speed threshold, the torque falls between the first torque/rotational speed interval.

In some implementations, the power control module 103 may determines whether the required torque of the electric vehicle is greater than the first torque threshold based on the driving intention M. If so, it represents that the motor 12 requires high current, so the power control module 103 may decides to supply power for the motor 12 by the first battery module 101 and the second battery module 102 in parallel (e.g., entering step S325). If not, the power control module 103 may further determines whether the required rotational speed of the electric vehicle is greater than the first rotational speed threshold based on the driving intention M.

In some implementations, if the power control module 103 determines that the required torque of the electric vehicle is not greater than the first torque threshold, and the required rotational speed is not greater than the first rotational speed threshold, the motor 12 does not require high voltage or high current. Then, the power control module 103 decides to supply power for the motor 12 from the first battery module 101 only (e.g., entering step S322).

In some implementations, if the power control module 103 determines that the required torque of the electric vehicle is not greater than the first torque threshold, and the required rotational speed is not greater than the first rotational speed threshold, the power control module 103 will further determine whether the required torque is not greater than the second torque threshold and whether the required rotational speed is not greater than the second rotational speed threshold. If the required torque is not greater than the second torque threshold and the required rotational speed is not greater than the second rotational speed threshold, the voltage and current required by the motor 12 are lower. Then the power control module 103 switches the power supplying configuration of the motor 12 to the power supply by the second battery module 102 only (e.g., entering step S323). Otherwise, if the required torque is greater than the second torque threshold or the required rotational speed is greater than the second rotational speed threshold, at least one of the voltage and current required by the motor 12 is not low. Then, the power control module 103 switches the power supplying configuration of the motor 12 to the power supply by the first battery module 101 only (e.g., entering step S322).

In some implementations, if the power control module 103 determines the required torque of the electric vehicle is not greater than the first torque threshold and the required rotational speed is greater than the first rotational speed threshold, the motor 12 requires high voltage. Therefore, the power control module 103 may switch the power supplying configuration of the motor 12 to the power supply by the first battery module 101 and the second battery module 102 in series (e.g., entering step S324), or switches the power supplying configuration of the motor 12 to the power supply by the first battery module 101 only (e.g., entering step S322).

In some implementations, if the power control module 103 determines that the required torque of the electric vehicle is not greater than the first torque threshold and the required rotational speed is greater than the first rotational speed threshold, whether the required torque is greater than the second torque threshold is further determined. If so, the power control module 103 may switch the power supplying configuration of the motor 12 to the power supply by the first battery module 101 and second battery module 102 in series (e.g., entering step S324). Otherwise, the power control module 103 may switch the power supplying configuration of the motor 12 to the power supply by the first battery module 101 only (e.g., entering step S322).

In step S322, the power control module 103 (e.g., the power supply switching device) switches the power supplying configuration of the motor 12 to the power supply by the first battery module 101 only.

In step S323, the power control module 103 (e.g., the power supply switching device) switches the power supplying configuration of the motor 12 to the power supply by the second battery module 102 only.

In step S324, the power control module 103 (e.g., the power supply switching device) switches the power supplying configuration of the motor 12 to the power supply by the first battery module 101 and the second battery module 102 in series to provide a higher voltage than the first battery module 101.

In some implementations, in step S324, the power control module 103 also switches the power supplying configuration of the motor 12 to the power supply by multiple swappable batteries in the second battery module 102 to parallel to avoid unrealistic large voltage range requirements for the subsequent energy conversion device 13.

In step S325, the power control module 103 (e.g., the power supply switching device) switches the power supplying configuration of the motor 12 to the power supply by the first battery module 101 and the second battery module 102 in parallel to provide a current higher than that of the first battery module 101.

In some implementations, the power control module 103 further switches the power supplying configuration of the motor 12 to the power supply by multiple swappable batteries in the second battery module 102 to series in step S325 to avoid a large voltage difference between the first battery module 101 and the second battery module 102, which reduces the lifespan of the battery modules.

In some implementations, the voltage adjusting device 104 adjusts the voltage difference between the first battery module 101 and the second battery module 102 in step S325 to avoid a large voltage difference between the first battery module 101 and the second battery module 102, which reduces the lifespan of the battery modules. For example, the voltage adjusting device 104 may receive signals from the battery management system to increase the voltage of the second battery module 102 and/or decrease the voltage of the first battery module 101.

It should be noted that the present disclosure is not limited to the example power supplying configuration corresponding to different driving intentions M, and those skilled in the art may adjust them according to the needs. In summary, the battery system and its control method provided in the implementations of the present disclosure expand the capacity and the voltage or current provided by the battery system by using swappable batteries, and may switch the power supplying configuration of the battery system of the motor according to the driving intention. Therefore, the convenience of battery replacement and the power supply efficiency of the battery system are improved.

Based on the above description, it is apparent that various techniques may be configured to implement the concepts described in this application without departing from their scope. Furthermore, although certain implementations have been specifically described and illustrated, those skilled in the art will recognize that variations and modifications may be made in form and detail without departing from the scope of the concepts. Thus, the described implementations are to be considered in all respects as illustrative and not restrictive. Moreover, it should be understood that this application is not limited to the specific implementations described above, but many rearrangements, modifications, and substitutions may be made within the scope of the present disclosure.

What is claimed is:

1. A battery system configured for an electric vehicle, the electric vehicle comprising a motor and a vehicle control unit for generating a driving intention, the battery system comprising:
a first battery module;
a second battery module configured to accommodate a plurality of swappable batteries;
a power control module coupled to the first battery module, the second battery module, the motor and the vehicle control unit, and configured to receive the driving intention from the vehicle control unit and switch a power supplying configuration of the motor based on the driving intention, wherein the power supplying configuration comprises a power supply by the first battery module only, a power supply by the second battery module only, a power supply by the first battery module and the second battery module in series, and a power supply by the first battery module and the second battery module in parallel.

2. The battery system of claim 1, further comprises:
at least one voltage adjusting device coupled between the first battery module, the second battery module and the motor, and configured to adjust a voltage difference between the first battery module and the second battery module when the first battery module and the second battery module are connected in parallel.

3. The battery system of claim 2, wherein adjusting the voltage difference between the first battery module and the second battery module comprises at least one of reducing a first output voltage of the first battery module and increasing a second output voltage of the second battery module.

4. The battery system of claim 1, wherein the driving intention comprises a required torque of the electric vehicle, and the power control module switches the power supplying configuration of the motor to the power supply by the first battery module and the second battery module in parallel when the required torque is greater than a first torque threshold.

5. The battery system of claim 4, wherein the driving intention further comprises a required rotational speed of the electric vehicle, and the power control module switches the power supplying configuration of the motor to the power supply by the first battery module and the second battery module in series when the required torque is less than or equal to the first torque threshold and the required rotational speed is greater than a first rotational speed threshold.

6. The battery system of claim 4, wherein the power control module switches the power supplying configuration of the motor to the power supply by the first battery module only or the second battery module only when the required torque is less than or equal to the first torque threshold.

7. The battery system of claim 6, wherein the driving intention further comprises a required rotational speed of the electric vehicle, the power control module switches the power supplying configuration of the motor to the power supply by the second battery module only when the required torque is less than or equal to a second torque threshold and the required rotational speed is less than or equal to a second rotational speed threshold.

8. The battery system of claim 1, further comprises:
a power management system coupled to the first battery module, the second battery module and the power control module, and configured to provide a current state of the first battery module and the second battery module to the power control module,
wherein the power control module switches the power supplying configuration of the motor based on the driving intention and the current state.

9. The battery system of claim 1, wherein the power control module further connects the plurality of swappable batteries of the second battery module in parallel when switching the power supplying configuration of the motor to the power supply by the first battery module and the second battery module in series.

10. The battery system of claim 1, wherein the power control module further connects the plurality of swappable batteries of the second battery module in series when switching the power supplying configuration of the motor to the power supply by the first battery module and the second battery module in parallel.

11. A control method of a battery system applicable in an electric vehicle, the battery system comprising a first battery module and a second battery module configured to accommodate a plurality of swappable batteries, and the control method comprising:
receiving a driving intention from a vehicle control unit; and
switching a power supplying configuration of a motor of the electric vehicle based on the driving intention, wherein the power supplying configuration comprises a power supply by the first battery module only, a power supply by the second battery module only, a power supply by the first battery module and the second battery module in series, and a power supply by the first battery module and the second battery module in parallel.

12. The control method of claim 11, wherein the battery system further comprises at least one voltage adjusting device coupled between the first battery module, the second battery module and the motor, and switching the power supplying configuration of the motor of the electric vehicle based on the driving intention comprises:
adjusting a voltage difference between the first battery module and the second battery module when the first battery module and the second battery module are connected in parallel.

13. The control method of claim 12, wherein adjusting the voltage difference between the first battery module and the second battery module comprises at least one of:
reducing a first output voltage of the first battery module and increasing a second output voltage of the second battery module.

14. The control method of claim 11, wherein the driving intention comprises a required torque of the electric vehicle, and switching the power supplying configuration of the motor of the electric vehicle based on the driving intention comprises:
determining whether the required torque is greater than a first torque threshold; and
when the required torque is determined to be greater than the first torque threshold, switching the power supplying configuration of the motor to the power supply by the first battery module and the second battery module in parallel.

15. The control method of claim 14, wherein the driving intention further comprises a required rotational speed of the electric vehicle, and switching the power supplying configuration of the motor of the electric vehicle based on the driving intention further comprises:
determining whether the required rotational speed is greater than a first rotational speed threshold when the required torque is determined to be less than or equal to the first torque threshold; and
when the required rotational speed is determined to be greater than the first rotational speed threshold, switching the power supplying configuration of the motor to the power supply by the first battery module and the second battery module in series.

16. The control method of claim 14, wherein switching the power supplying configuration of the motor of the electric vehicle based on the driving intention further comprises:
when the required torque is determined to be less than or equal to the first torque threshold, switching the power supplying configuration of the motor to the power supply by the first battery module only or the second battery module only.

17. The control method of claim 16, wherein the driving intention further comprises a required rotational speed of the electric vehicle, and switching the power supplying configuration of the motor of the electric vehicle based on the driving intention further comprises:
when the required torque is determined to be less than or equal to the first torque threshold, determining whether the required torque is greater than a second torque threshold;
when the required torque is determined to be less than or equal to the second torque threshold, determining whether the required rotational speed is greater than a second rotational speed threshold; and
when the required rotational speed is determined to be less than or equal to the second rotational speed threshold, switching the power supplying configuration of the motor to the power supply by the second battery module only.

18. The control method of claim 11, further comprises:
acquiring a current state of the first battery module and the second battery module; and
switching the power supplying configuration of the motor based on the driving intention and the current state.

19. The control method of claim 11, wherein switching the power supplying configuration of the motor of the electric vehicle comprises:
connecting the plurality of swappable batteries of the second battery module in parallel when switching the power supplying configuration of the motor to the power supply by the first battery module and the second battery module in series.

20. The control method of claim 11, wherein switching the power supplying configuration of the motor of the electric vehicle comprises:
connecting the plurality of swappable batteries of the second battery module in series when switching the power supplying configuration of the motor to the power supply by the first battery module and the second battery module in parallel.
